(19) United States
(12) Patent Application Publication
(10) Pub. No.: US 2009/0148217 A1
(43) Pub. Date: Jun. 11, 2009

(54) THERMAL PRINTER

(76) Inventors: Tsuyoshi Sanada, Singapore (SG); Toshiharu Sekino, Izu-shi (JP)

Correspondence Address: PATTERSON & SHERIDAN, L.L.P., 3040 POST OAK BOULEVARD, SUITE 1500, HOUSTON, TX, 77056, US

(21) Appl. No.: 11/952,034

(22) Filed: Dec. 6, 2007

(51) Int. Cl. B41J 2/32

(52) U.S. Cl. 400/120.16

(57) ABSTRACT

A thermal printer includes a printer body, a cover attached to the printer body so as to be rockable between closed and open states, a platen roller provided on the printer body or cover, a thermal head provided on the cover or printer body and configured to be opposed to and press the platen roller when the cover is in the closed state, a first cutter provided on the printer body or cover and configured to cut a recording medium being transported on the downstream side of the printer body with respect to the thermal head, a second cutter provided on the cover or printer body and opposed to the first cutter when in the closed state, and a retraction mechanism configured to retract one of the first and second cutters from the other in association with a motion of the cover when the cover is closed.

### 1. FIELD OF THE INVENTION

The present invention relates to a thermal printer, and more particularly, to a thermal printer furnished with a cutter for cutting a recording medium.

### 2. DESCRIPTION OF THE RELATED ART

There is known a thermal printer in which a cover is swingably mounted on a printer body, and a thermal head and a platen roller are provided on the sides of the printer body and the cover, respectively. In the thermal printer of this type, a recording medium is transported between the head and the roller. One cutter of a cutter mechanism for cutting the medium is disposed on the cover side and the other cutter on the printer body side, on the downstream side in the transporting direction. When the cover is in a closed state, the recording paper is cut between the cutters.

This technique, however, involves the following problems. Since the cutters sometimes come into contact with each other as the cover is closed, they may hinder open-close operations of the cover and possibly be broken.

As described in U.S. Pat. No. 6,118,469, for example, there is a printing device in which a platen roller and a thermal head are arranged on one and the other sides, respectively. In order to reduce interference between the roller and the head to enable smooth open-close operations, this printing device is configured so that the cylindrical roller of an elastic material presses a slope formed on the head, whereby the head is rotated to retract from the roller. However, there is no printer that is designed to avoid contact between cutters.

Accordingly, the object of the present invention is to provide a printing device in which a cover can be opened and closed easily and smoothly without damaging the function of cutters.

### BRIEF SUMMARY OF THE INVENTION

A thermal printer according to an aspect of the present invention comprises a printer body, a cover attached to the printer body so as to be rockable between a closed state and an open state, a platen roller provided on one side, whether on the printer body or on the cover, a thermal head provided on the other side, whether on the cover or on the printer body, and configured to be opposed to and press the platen roller when the cover is in the closed state, a first cutter provided on the one side, whether on the printer body or on the cover, and configured to cut a recording medium being transported on the downstream side of the printer body with respect to the thermal head, a second cutter provided on the other side, whether on the cover or on the printer body, and opposed to the first cutter when in the closed state, and a retraction mechanism configured to retract one of the first and second cutters from the other in association with a motion of the cover when the cover is closed.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a perspective view showing the interior of a thermal printer according to a first embodiment of the invention in an open state;

FIG. 2 is a side view showing the interior of the thermal printer in a closed state;

FIG. 3 is a side view showing the interior of the thermal printer in the open state;

FIG. 4 is a side view showing an engaging hook and a rotary cutter mechanism of the thermal printer;

FIG. 5 is a side view showing the rotary cutter mechanism of the thermal printer;

FIG. 6 is a side view for illustrating open-close operations of the thermal printer; and

FIG. 7 is a perspective view showing a stationary cutter mechanism.

### DETAILED DESCRIPTION OF THE INVENTION

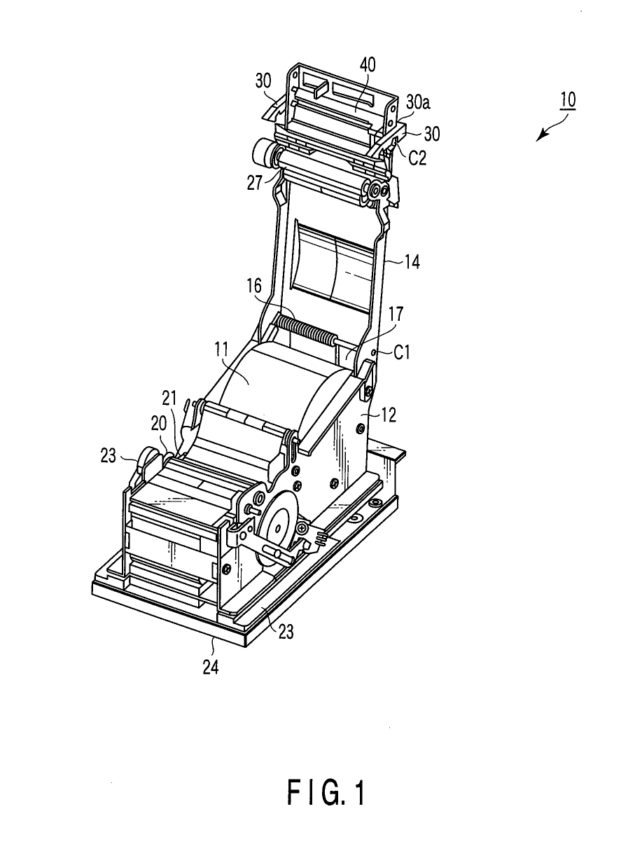

A thermal printer 10 according to an embodiment of the present invention will now be described with reference to FIGS. 1 to 6. In each of the drawings, configurations are schematically shown as required with some omissions.

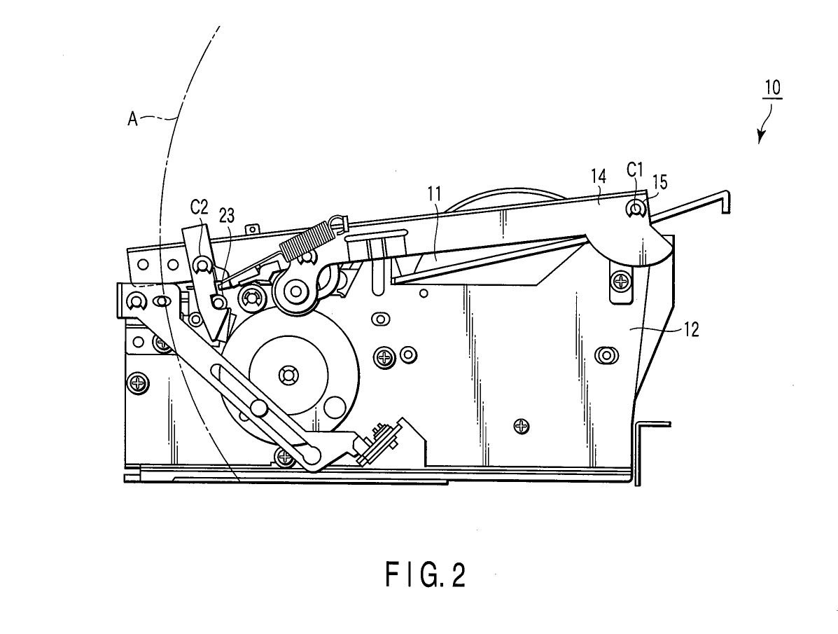

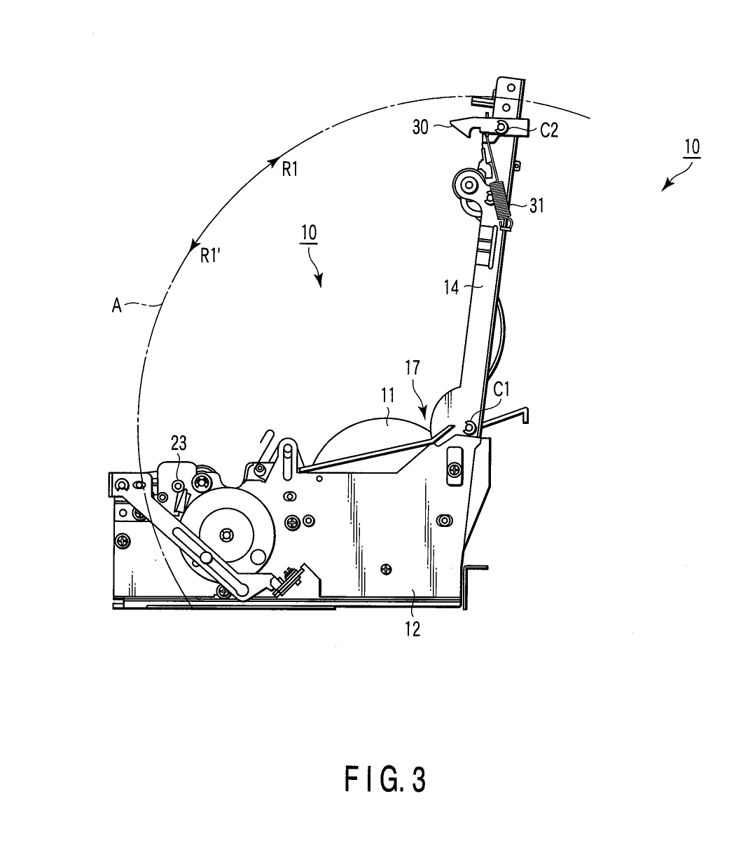

FIG. 1 is a perspective view showing the thermal printer 10 in an open state. FIGS. 2 and 3 are side views of the thermal printer 10, showing a open state and the closed state, respectively.

The thermal printer 10 has a function for printing on a thermal paper 11 and can be used for a cash register in a store or the like. The thermal printer 10 is provided with an open-topped printer body 12 and a cover 14 that covers an opening of the printer body. The cover 14 is mounted for swinging motion around a central shaft C1 by a hinge portion 15 that is formed over the printer body 12.

The hinge portion 15 is provided with a torsion spring 16 for use as an urging member. The torsion spring 16 urges the cover 14 in an opening direction (direction of arrow R1) with respect to the printer body 12.

The cover 14 is opened when a paper jam, if any, is to be removed or the thermal paper 11 is to be supplied. The cover 14 is closed after the paper 1 is supplied. In the closed state, the thermal paper 11 undergoes a printing or cutting process.

A paper holding portion 17 that stores the thermal paper 11 is disposed at the rear part of the interior of the printer body 12. The thermal paper 11 is composed of a base sheet and a thermosensitive layer formed on one side (e.g., obverse surface) of the base sheet. The thermosensitive layer is formed of a material that turns into a desired color, e.g., black or red, when heated to a predetermined or higher temperature. The thermal paper 11 is wound in a roll in the paper holding portion 17 in a manner such that the thermosensitive layer faces outward.

A thermal head unit 20 is provided in front of the printer body 12. It includes a thermal head 21, a heat sink (not shown), an urging member (not shown) for urging the head 21 toward a platen roller, etc. When in the closed state, the thermal head 21 is in contact with the thermosensitive layer of the thermal paper 11 and located opposite a platen roller 27 with the paper 11 therebetween.

A motor for use as a drive source and a transmission mechanism, including various gears, are disposed in front of the paper holding portion 17 in the printer body 12. When the motor is driven, the platen roller 27 is rotated by means of the transmission mechanism.

Engaging pins (engaging members) 23 are arranged individually on the left- and right-hand sides of the printer body 12. Each engaging pin 23 is in the form of a cylindrical column that has a horizontal axis. In the closed state, the engaging pins 23 are situated individually inside respective engagement recesses 33 of engaging hooks 30 (mentioned later), thereby engaging the recesses 33.

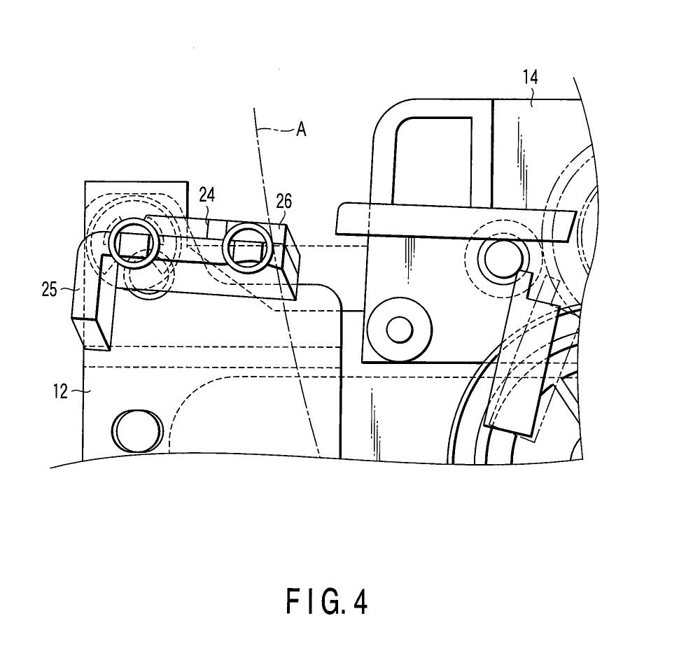

A rotary cutter mechanism 24 is provided on the front end portion (left-hand end portion in FIG. 1) of the printer body 12. As shown in the enlarged views of FIGS. 4 and 6, the cutter mechanism 24 is located on the downstream side of a transport path in front (on the left-hand side in FIG. 2) of the thermal head 21. The mechanism 24 is composed of an L-profiled support member 25 and a rotary blade portion (second cutter) 26 formed on the rear side (right-hand side) of the upper surface of the support member 25. The blade portion 26 is a sharp-edged portion that is formed of a very hard material, such as M2.

The platen roller 27 is disposed on the distal end side or a front part (left-hand part in FIG. 2) of the cover 14 in the closed state. The roller 27 is mounted integrally on a rotatable platen shaft that is supported on the left- and right-hand portions of the cover 14 by bearings and extends horizontally.

The platen roller 27 is a horizontally extending cylindrical column, which can rotate integrally with the platen shaft. The roller 27 is formed of an elastic material, such as silicone rubber. The roller 27 is located so as to face the thermal head 21 (mentioned later) with the thermal paper 11 therebetween in the closed state.

The engaging hooks 30 are attached individually to the opposite side portions of the cover 14 by a central shaft C2. The opposite engaging hooks 30 are connected to each other by a connecting member 30a that extends horizontally. The engaging hooks 30 and the engaging pins 23 constitute a locking mechanism.

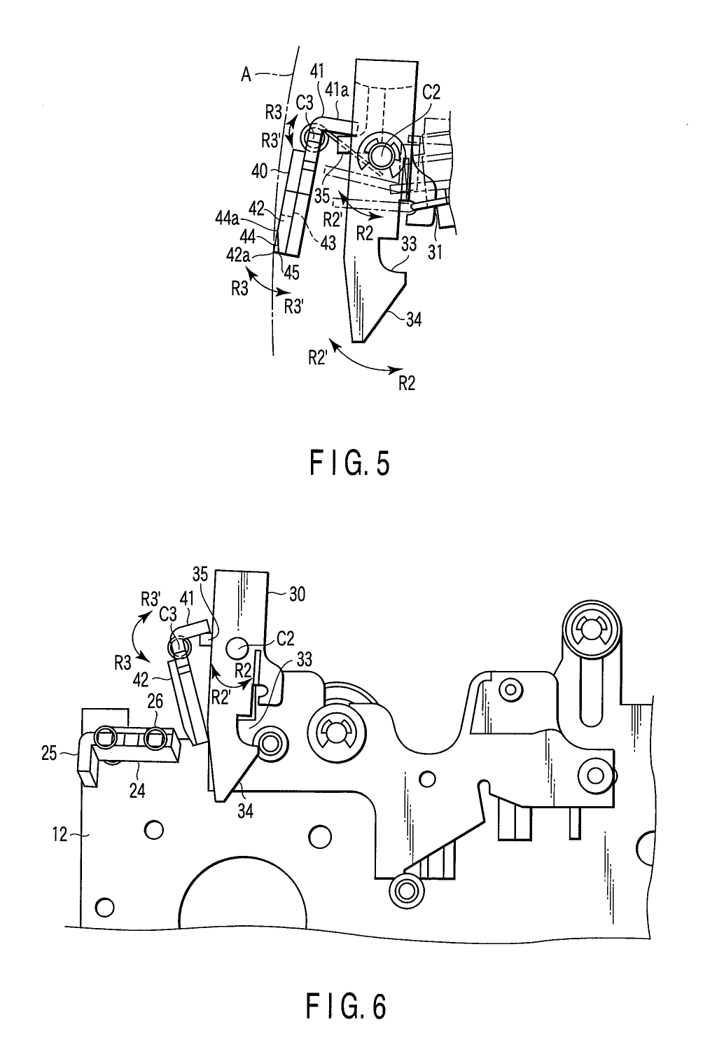

Each engaging hook 30 shown in the enlarged views of FIGS. 5 and 6 is rockable around the central shaft C2 and is urged in the direction of arrow R2 by a spring member 31 for use as urging means. The engagement recess 33 that engages the engaging pin 23 is formed in the back of the lower part of the engaging hook 30. A downwardly tapered portion 34 is formed on the back of the lower end of the engaging hook 30 below the engagement recess. From the front portion of the engaging hook 30 protrudes a projection 35 that serves to press a stationary cutter (mentioned later) as the hook rocks.

Further, a stationary cutter mechanism 40 is provided on the front end portion of the cover 14 on the downstream side of the transport path with respect to the platen roller 27. The stationary cutter mechanism 40 shown in the enlarged view of FIG. 5 is composed of an L-shaped support member 41 and a stationary blade portion (first cutter) 42 formed on the front surface of the lower part of the support member 41. The stationary blade portion 42 is a sharp-edged portion that is formed of a very hard material, such as M2.

The support member 41 is rockable around a central shaft C3 that extends horizontally from side to side (depthwise, as illustrated in the side views such as FIG. 2). That part of the support member 41 which is situated on the stationary blade portion 42 side below the central shaft C3 is pressed in the direction of arrow R3 toward the rotary blade portion 26 in the closed state by a spring member 43 for use as urging means.

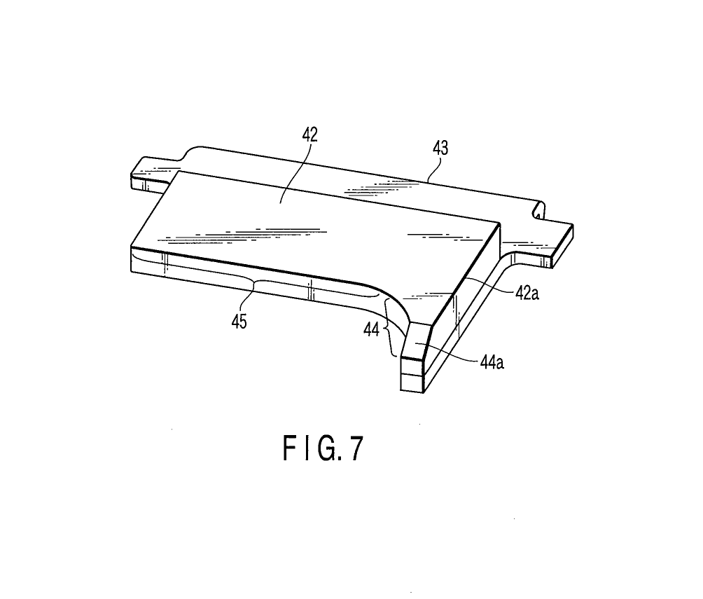

As shown in FIGS. 5 and 7, a lug-shaped contact guide 44 is formed on an end portion 42a of the stationary blade portion 42 on the cutting start side. The contact guide 44 is tapered. A distal end 44a of the guide 44 is more distant from the central shaft C1 than a cutting edge 45 is.

In the drawings, curve A is a circular arc around the central shaft C1 that connects positions of the distal end 44a of the contact guide 44 in the open and closed states. The directions of arrows R1 and R2 extend along this curve.

The stationary cutter mechanism 40 is located ahead of the engaging hooks 30, and the support member 41 includes an upper piece 41a that extends rearward from its upper part. When the projection 35 moves as the engaging hook 30 rocks in the direction of arrow R2′ around the central shaft C2, the upper piece 41a is pressed by the projection 35. Thereupon, the support member 41 rocks in the direction of arrow R3′ around the central shaft C3.

The stationary blade portion 42 that is fixed to the support member 41 moves in the direction of arrow R3′ around the central shaft C3, and is located so that its contact guide 44 is retracted away from the cutter mechanism 24 side.

When the engaging hook 30 gets over the engaging pin 23, moreover, it is urged in the direction of arrow R2 to restore its original orientation with respect to the cover 14 by the spring member 31, and the engaging pin 23 relatively gets into the engagement recess 33 of the engaging hook 30.

Thus, the engaging pin 23 and the engaging hook 30 engage each other, whereupon the closed state shown in FIG. 2 is established and maintained. In the closed state, the rotary blade portion 26 and the stationary blade portion 42 are located in a state for cutting with the thermal paper 11 interposed between them. At the same time, the thermal head 21 is pressed against the platen roller 27 with the paper 11 between them, whereupon a state for printing is established.

The distal end portion of the rolled thermal paper 11 stored in the paper holding portion 17 can be discharged forward through spaces between the thermal head 21 and the platen roller 27 and between the rotary blade portion 26 and the stationary blade portion 42.

As the rotary cutter mechanism 24 is then driven, the thermal paper 11 is cut by a cutter system that is composed of the stationary and rotary cutter mechanisms 40 and 24.

The following is a description of operations for opening and closing the cover in the thermal printer 10 according to the present embodiment.

If a force is applied in a direction such that the cover is closed from the open state shown in FIGS. 1 and 2, the cover 14 rocks in the direction of arrow R1′ (opposite to R1) around the central shaft C1, resisting the urging force of the spring member 16. At the same time, the engaging hook 30 and the stationary cutter mechanism 40 at the distal end portion of the cover moves downward and forward.

With this movement, the lower end of the engaging hook 30 comes into contact with the engaging pin 23. If a force to rock the cover 14 in the direction of arrow R1′ acts, moreover, the engaging hook 30 rocks in the direction of arrow R2′ (opposite to R2) around the central shaft C2, resisting the urging force of the spring member 31, as shown in FIG. 6, and the engaging pin 23 relatively moves along the tapered portion 34.

When the engaging hook 30 rocks in the direction of arrow R2, the projection 35 on the upper part of the front surface of the hook 30 presses the upper piece 41a of the support member 41. Thereupon, the support member 41 rocks in the direction of arrow R3′ (opposite to R3) around the central shaft C3, resisting the urging force of the spring member 43.

As the support member 41 rocks in this manner, the stationary blade portion 42 on the front surface of the lower end portion of the support member 41 moves rearward and upward, and the distal end 44a of the contact guide 44 is deviated from the trajectory A1 and retracted away from the rotary blade portion 26.

When the engaging pin 23 relatively moves along the tapered portion 34 as the engaging hook 30 rocks, moreover, the tapered portion 34 gets over the engaging pin 23, whereupon the pin 23 gets into the engagement recess 33.

When the tapered portion 34 gets over the engaging pin 23, the engaging hook 30 is rocked in the direction of arrow R2 to restore its original orientation by the urging force of the spring member 31. When the engaging pin 23 is located in the engagement recess 33, the hook 30 and the pin 23 engage each other, whereby the cover 14 is kept in the closed state.

As the engaging hook 30 rocks in this manner, the projection 35 moves in the direction of arrow R2 and releases its press, whereupon the support member 41 is rocked in the direction of arrow R3 to restore its original orientation by the urging force of the spring member 43. As this is done, the stationary blade portion 42, having so far been retracted, approaches the rotary blade portion 26, whereupon these blade portions are ready to cut the thermal paper 11.

In opening the closed cover 14, on the other hand, the engaging hook 30 is rocked, for example, in the direction of arrow R2′, whereupon the individual members operate in sequences the reverse of those for the case where the cover is closed. Thus, when the engaging hook 30 is temporarily moved in the direction of arrow R2′, the support member 41 is rocked in the direction of arrow R3′ by the projection 35 in the same manner as aforesaid, and the stationary blade portion 42 is retracted. When the engaging pin 23 is disengaged from the engagement recess 33, thereafter, the engagement between the cover 14 and the printer body 12 is canceled. Then, the cover 14 is rocked in the direction of arrow R1 by the spring member 16, the engaging hook 30 is rocked in the direction of arrow R2 by the spring member 31, and the support member 41 is rocked in the direction of arrow R3 to restore its original orientation by the spring member 43, whereupon the opening state is established.

The thermal printer 10 according to the present embodiment has the following effects. In closing the cover 14, the stationary blade portion 42 is temporarily retracted from the rotary blade portion 26. By doing this, contact between the blade portions 26 and 42 can be prevented to enable smooth open-close operations, and the cutter mechanisms 40 and 24 can be prevented from being damaged.

Even in the case of the forward (leftward in FIG. 2) discharge structure according to the present embodiment or a structure in which the contact guide 44 is projected beyond the cutting edge of the stationary blade portion, in particular, contact between the respective edge surfaces of the cutter mechanisms can be prevented by enabling the distal end 44a of the contact guide 44 to retract. Therefore, grinding need not be performed for chamfering. Thus, the machining time and costs for the case where a very hard material, such as M2, is used can be reduced.

Since the operation for retraction is performed as the engaging hook 30 of the locking mechanism for engaging with or disengaging the cover 14 from the printer body 12 rocks, moreover, it can be easily achieved based on the open-close operations alone.

The present invention is not limited to the embodiment described above. In the foregoing first embodiment, for example, the thermal head unit 20 and the platen roller 27 are located on the sides of the printer body 12 and the cover 14, respectively. However, the thermal head unit 20 and the platen roller 27 may be arranged individually on alternative sides. Also, the present invention may be applied to a thermal printer for double-sided printing in which the printer body 12 and the cover 14 are provided with the thermal head unit 20 and the platen roller 27 each. Further, the engaging hook 30 and the engaging pin 23 may be located on the sides of the printer body 12 and the cover 14, respectively. Furthermore, the rotary and stationary cutter mechanisms may be arranged reversely.

In the foregoing first embodiment, moreover, the force in the direction of arrow R1 is applied by manually pressing the cover 14. However, the open-close method is also applicable to configurations of a button type, a lever type, and any other suitable type.

It is to be understood, in carrying out the present invention, that the components of the invention may be variously modified without departing from the spirit or scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the inventive as defined by the appended claims and their equivalents thereof.

What is claimed is:

1. A thermal printer characterized by comprising:
a printer body;
a cover attached to the printer body so as to be rockable between a closed state and an open state;
a platen roller provided on one side, whether on the printer body or on the cover;
a thermal head provided on the other side, whether on the cover or on the printer body, and configured to be opposed to and press the platen roller when the cover is in the closed state;
a first cutter provided on the one side, whether on the printer body or on the cover, and configured to cut a recording medium being transported on the downstream side of the printer body with respect to the thermal head;
a second cutter provided on the other side, whether on the cover or on the printer body, and opposed to the first cutter when in the closed state; and
a retraction mechanism configured to retract one of the first and second cutters from the other in association with a motion of the cover when the cover is closed.

2. A thermal printer according to claim 1, characterized in that the retraction mechanism retracts the cutter in association with a locking motion by a locking mechanism which causes the cover to engage the printer body or cancels the engagement.

3. A thermal printer according to claim 1, characterized in that the locking mechanism includes an engaging hook rockably provided on the one side, whether on the printer body or on the cover, and an engaging member provided on the other side, whether on the cover or on the printer body, the engaging hook having a recess capable of accommodating the engaging member and being adapted to temporarily rock in one direction when the cover is closed, and the one cutter is rockably provided on the cover and configured to temporality rock pressed by the engaging hook as the engaging hook rocks in the one direction, thereby temporarily retracting away from the other cutter.

4. A thermal printer according to claim 3, characterized in that the engaging hook is urged in a direction opposite to the rocking direction by urging means, has an inclined tapered surface on the distal end side with respect to the engagement recess, and includes a projection which presses the one cutter as the engaging hook rocks, and the one cutter is supported by a rockable support member, which is located near the engaging hook and pressed by the projection, and is urged toward the other cutter in the closed state by urging means.

5. A thermal printer according to claim 4, characterized in that the projection moves to press the support member located nearby when the engaging hook rocks against the urging force, whereupon the support member rocks against the urging force and the one cutter retracts from the other cutter, and the engaging hook is rocked in a restoring direction thereof by the urging force when the engaging member gets over the tapered surface and gets into the accommodating recess of the engaging hook, whereupon the projection moves in a restoring direction, the support member is rocked in a restoring direction thereof, and the one cutter is urged toward the other cutter in the closed state by urging means.
